(19) United States
(12) Patent Application Publication
(10) Pub. No.: US 2014/0080362 A1
(43) Pub. Date: Mar. 20, 2014

(54) CONNECTOR

(71) Applicant: JAPAN AVIATION ELECTRONICS INDUSTRY, LIMITED, Tokyo (JP)

(72) Inventors: Yukiko SATO, Tokyo (JP); Takashi TOKUNAGA, Tokyo (JP)

(73) Assignee: JAPAN AVIATION ELECTRONICS INDUSTRY, LIMITED, Tokyo (JP)

(21) Appl. No.: 14/015,479

(22) Filed: Aug. 30, 2013

(30) Foreign Application Priority Data
Sep. 18, 2012 (JP) 2012-204154

(51) Int. Cl. H01R 13/502

(52) U.S. Cl. CPC H01R 13/502
USPC 439/701

(57) ABSTRACT

A connector includes contacts and a housing. The contacts constitute two differential pairs. Each contact has a first portion, a second portion and a coupling portion. The first portion is press-fitted into and held by the housing. The first portion has a contact portion to be brought into contact with a mating connector. The second portion is to be connected with and fixed on a board. The coupling portion couples the first portion with the second portion. The first portions are arranged in a single row while the second portions are arranged in two rows. The first portions are larger in width than the second portions and the coupling portions. The second portions of the contacts constituting one differential pair belong to the rows different from each other.

### CROSS REFERENCE TO RELATED APPLICATIONS

An applicant claims priority under 35 U.S.C. §119 of Japanese Patent Application No. JP2012-204154 filed Sep. 18, 2012.

### BACKGROUND OF THE INVENTION

The present invention relates to a USB (Universal Serial Bus) connector which comprises contacts constituting differential pairs.

A connector to be mounted on a board includes contacts, each of which has a fixing portion and a contact portion, wherein the fixing portion is to be fixed to and connected with the board, and the contact portion is arranged in a mating portion for a mating connector. The board is provided with fixed portions such as through holes. There are physical and electrical limitations on the arrangement of the fixed portions. On the other hand, the demand of fine pitch of the contact portions is increasing. Therefore, pitch and arrangement of the fixing portions are required to be different from pitch and arrangement of the contact portions. Namely, pitch conversion is required. The connector with pitch conversion is disclosed in, for example, Patent Document 1 (JP-A 2011-9151).

As shown in FIG. 10, according to the connector of Patent Document 1, fixing portions, i.e. portions near a board, of contacts which constitute the differential pairs are arranged in two rows. In addition, to reduce impedance miss-matching, widths of the fixing portions are larger than widths of contact portions, i.e. portions near a mating portion, of the contacts (see, for example, paragraph 0033 of Patent Document 1).

As shown in FIG. 11, Patent Document 2 (JP-A 2009-272290) discloses a USB connector which includes contacts constituting two differential pairs. The differential pairs are used for high-speed signal transmission.

### SUMMARY OF THE INVENTION

It is an object of the present invention to improve transmission properties of a connector which includes contacts constituting at least two differential pairs.

For example, if the impedance miss-matching reduction technique of Patent Document 1 is applied to the two differential pairs of the connector of the Patent Document 2, crosstalk might occur between the two differential pairs because the minimum distance between the contact included in one of the differential pairs and the contact included in the other differential pair becomes shorter.

To prevent the crosstalk, it is effective to arrange the differential pairs as far away from each other as possible. In detail, the contacts have outside portions, respectively, which are positioned outside the housing. Widths of the outside portions are designed as narrow as possible. The outside portions are provided with bent portions, respectively, which are used for pitch conversion so that the pitches of the contacts are converted outside the housing.

One aspect of the present invention provides a connector which is to be mounted on a board and is connectable with a mating connector in a predetermined direction. The connector comprises contacts and a housing. The contacts constitute two differential pairs. The housing holds the contacts. Each of the contacts has a first portion, a second portion and a coupling portion. The first portion is press-fitted into and held by the housing. The first portion has a contact portion to be brought into contact with the mating connector. The second portion is to be connected with and fixed on the board. The coupling portion couples the first portion with the second portion. The first portions are arranged in a single row while the second portions are arranged in two rows. Widths of the first portions are larger than widths of the second portions and the coupling portions in a width direction perpendicular to the predetermined direction. The second portions of the two contacts constituting one of the differential pairs belong to the rows different from each other.

An appreciation of the objectives of the present invention and a more complete understanding of its structure may be had by studying the following description of the preferred embodiment and by referring to the accompanying drawings.

### BRIEF DESCRIPTION OF THE DRAWINGS:

FIG. 1 is a front, perspective view showing a connector according to an embodiment of the present invention.

FIG. 2 is a rear, perspective view showing the connector of FIG. 1.

FIG. 3 is an exploded, perspective view showing the connector of FIG. 1.

FIG. 4 is a front view showing the connector of FIG. 1.

FIG. 5 is a rear view showing the connector of FIG. 1.

FIG. 6 is a perspective view showing only USB 3.0 contacts included in the connector of FIG. 3.

FIG. 7 is a side view showing the USB 3.0 contacts of FIG. 6.

FIG. 8 is another side view showing the USB 3.0 contacts of FIG. 6.

FIG. 9 is a rear view showing the USB 3.0 contacts of FIG. 6.

FIG. 10 is a perspective view showing contacts of a connector of Patent Document 1.

FIG. 11 is a perspective view showing a connector of Patent Document 2.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

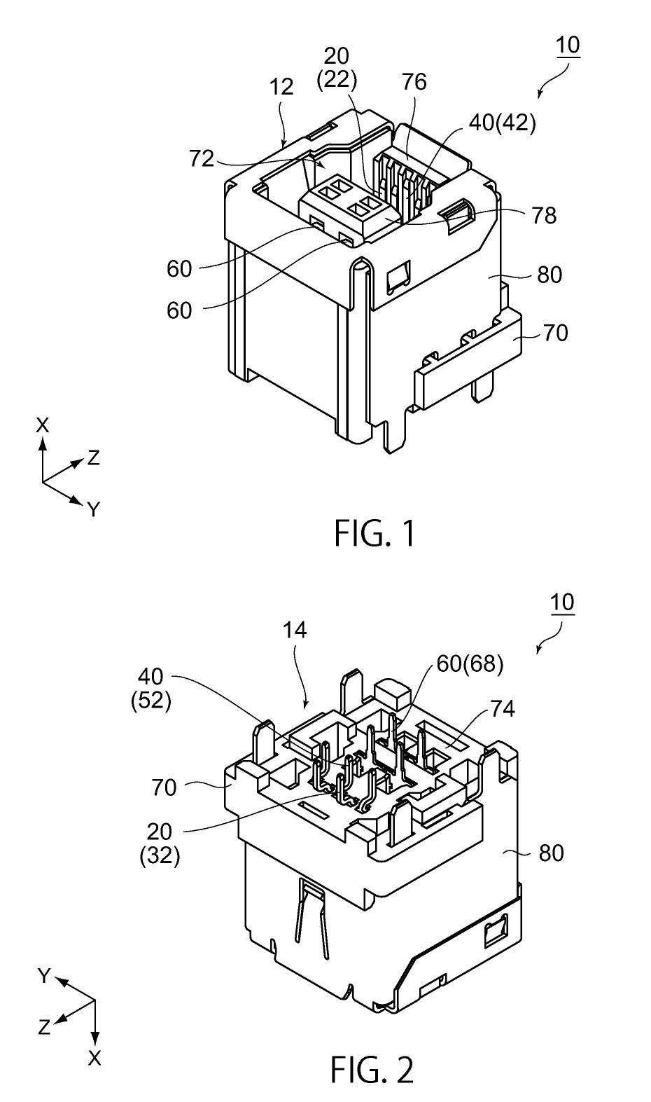

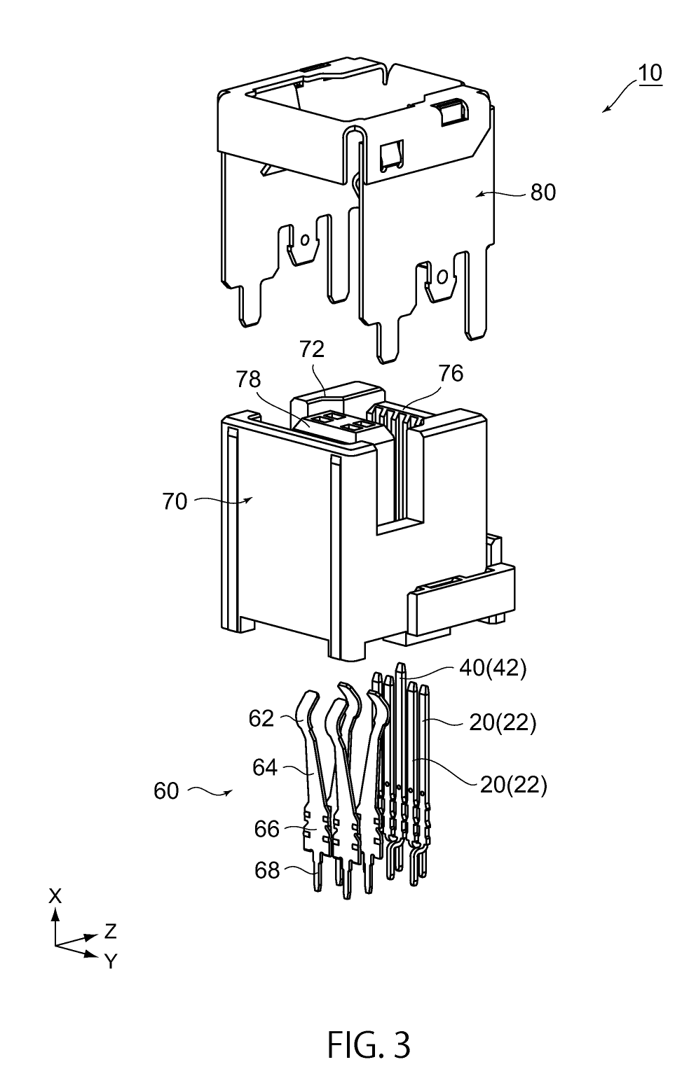

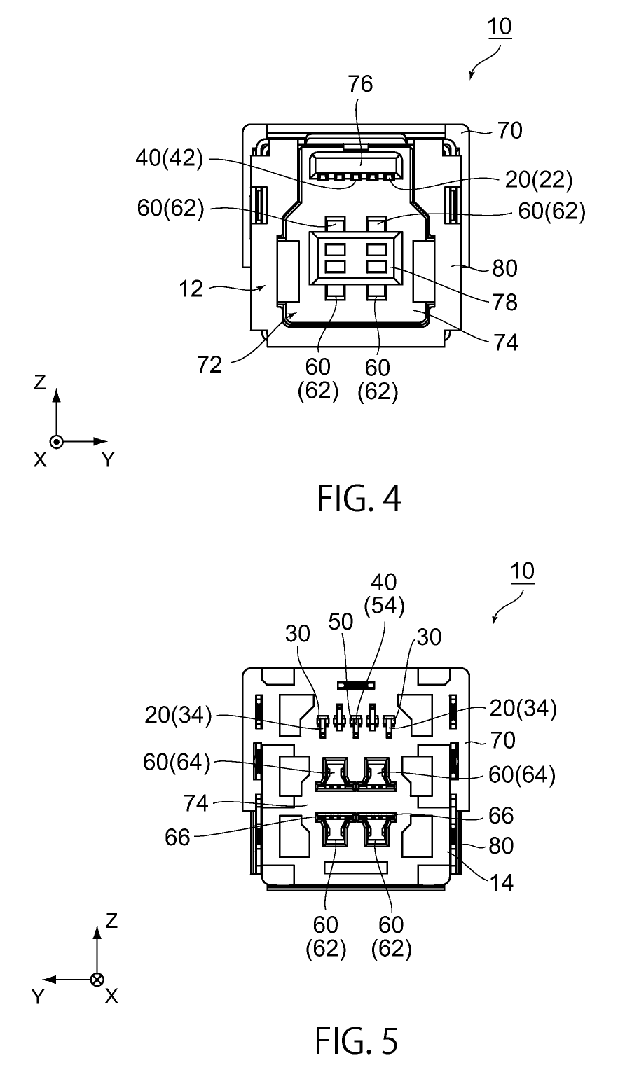

As shown in FIG. 1 to FIG. 5, the connector 10 according to an embodiment of the present invention is a receptacle compliant with the USB 3.0 Standard-B. The connector 10 has a mating end 12 and a board-mount end 14. The mating end 12 is matable with a mating connector (not shown) along an X-direction (predetermined direction). The board-mount end 14 is configured to be mounted on a board (not shown). The X-direction, or the predetermined direction, is perpendicular to the board (not shown). A mating surface of the connector 10 is in parallel with the board (not shown). In other words, the connector 10 of the present embodiment is straight type, a mating direction of which is perpendicular to the board (not shown). The illustrated connector 10 comprises four USB 3.0 contacts (contacts) 20, a USB 3.0 contact (ground contact: specific contact) 40, four USB 2.0 contacts 60, a housing 70 and a shell 80. Each of the USB 3.0 contacts 20, the USB 3.0 contact 40 and the USB 2.0 contacts 60 is made of conductor. The housing 70 is made of insulator and holds the USB 3.0 contacts 20, the USB 3.0 contact 40 and the USB 2.0 contacts 60. The shell 80 is made of metal and partially covers the housing 70.

The housing 70 opens at the mating end 12. The housing 70 has a receiving portion 72, an inner wall portion 74, a plate-like portion 76 and a block portion 78. The receiving portion 72 receives the mating connector (not shown) in part. The inner wall portion 74 is a bottom portion of the receiving portion 72. The plate-like portion 76 and the block portion 78 extend toward the mating end 12 from the inner wall portion 74 within the receiving portion 72 along the X-direction. Five grooves are formed on a negative Z-side (inner side) surface of the plate-like portion 76. The USB 3.0 contacts 20 and the USB 3.0 contact 40 are arranged and held in the five grooves, respectively. Two grooves are formed on each of a positive Z-side surface and a negative Z-side surface of the block portion 78. In other words, the block portion 78 has the four grooves in total. The USB 2.0 contacts 60 are arranged and held in four grooves, respectively.

The USB 2.0 contact 60 has a contact portion 62, a spring portion 64, a press-fitted portion 66 and a fixing portion 68. The contact portion 62 is configured to be brought into contact with a contact (not shown) of the mating connector (not shown). The spring portion 64 resiliently supports the contact portion 62. The press-fitted portion 66 is positioned closer to the board-mount end 14 than the spring portion 64 and is press-fitted into the inner wall portion 74 of the housing 70. The fixing portion 68 is configured to be fixed to the board (not shown). The USB 2.0 contact 60 is held by the housing 70 so that the spring portion 64 is movable and deformable within the groove of the block portion 78.

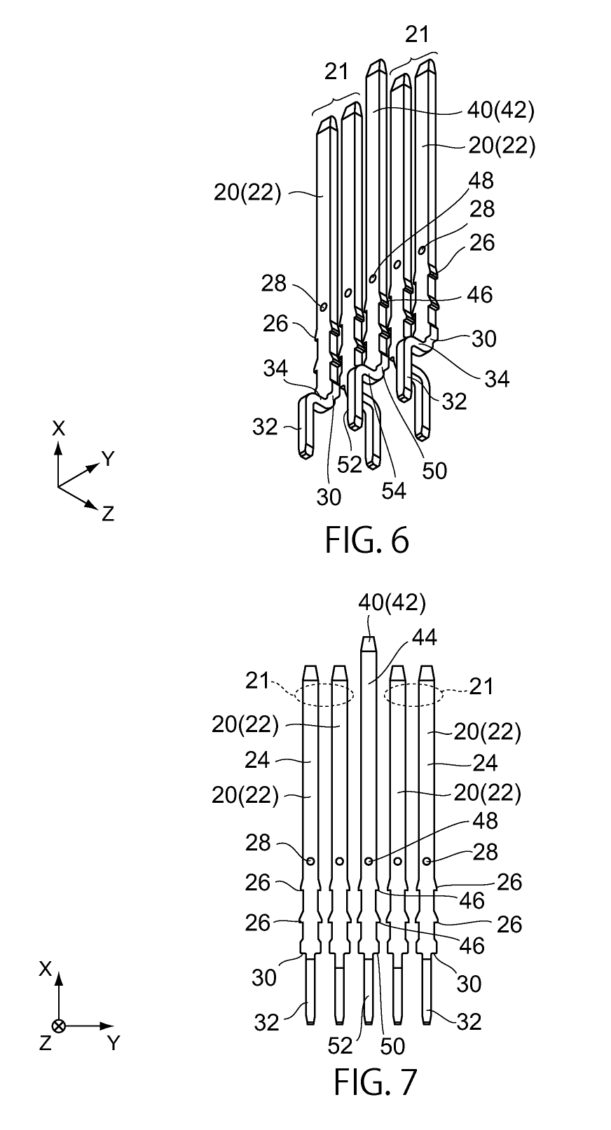

As shown in FIG. 6 and FIG. 7, the USB 3.0 contacts 20 constitute two differential pairs 21. The USB 3.0 contact 40 is a ground contact provided between two differential pairs 21 in a Y-direction (width direction).

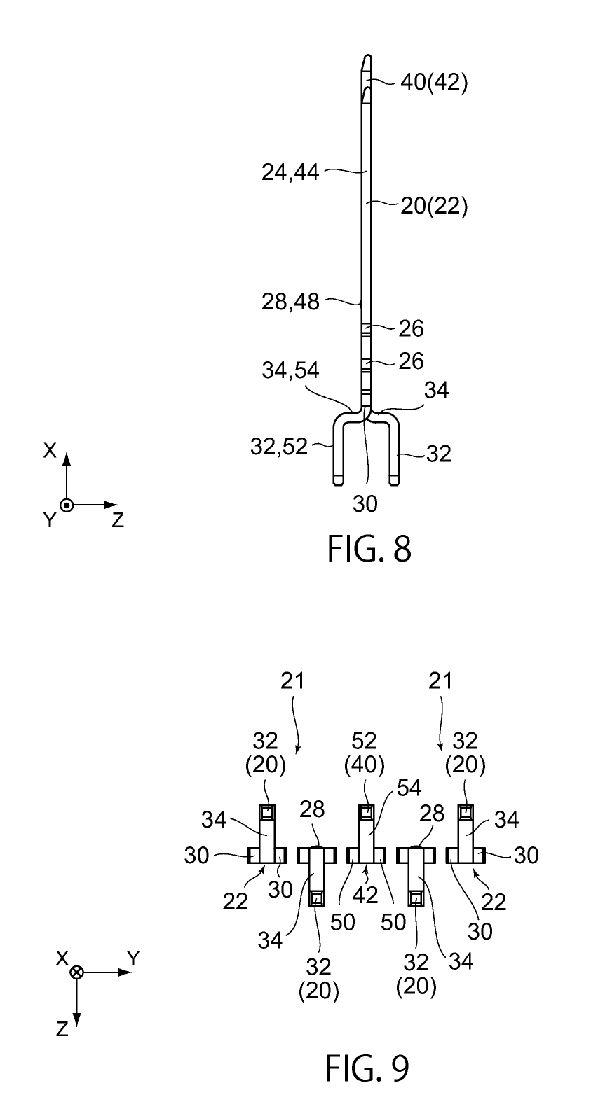

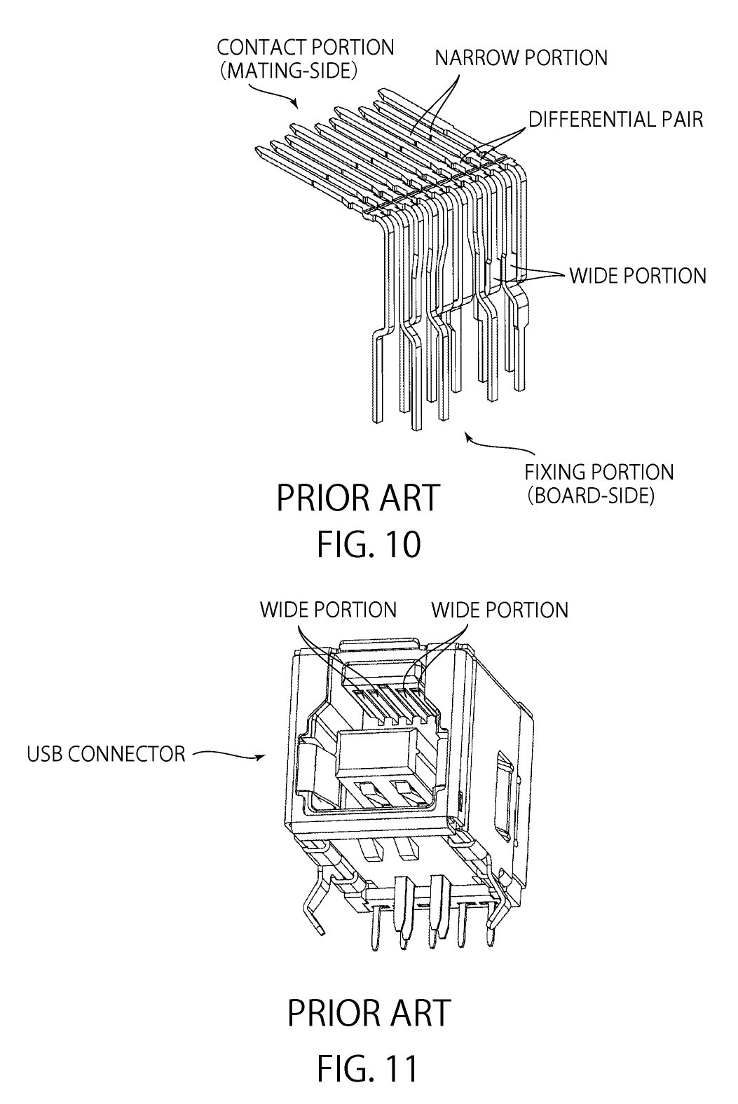

In detail, as shown in FIG. 6 to FIG. 9, the USB 3.0 contact 20 has a first portion 22, a second portion 32 and a coupling portion 34. The first portion 22 has a contact portion 24 which is configured to be brought into contact with a contact (not shown) of the mating connector (not shown). The first portion 22 has a long and narrow plate-like shape extending in the X-direction. The first portion 22 is formed with press-fitted projections 26 and a projection 28. The press-fitted projections 26 are press-fitted in the inner wall portion 74 of the housing 70. When the press-fitted projections 26 are press-fitted into the housing 70, the projection 28 presses the first portion 22 onto an inner surface of the groove of the plate-like portion 76 so that the positioning of the first portion 22 is performed. The first portion 22 has two end portions: one end portion in the positive X-direction (one of the end portions of the first portion 22 closer to the mating end 12) and the other end portion in the negative X-direction (one of the end portions of the first portion 22 closer to the board-mount end 14). A shoulder portion 30 is provided on the end portion in the negative X-direction of the first portion 22. The shoulder portion 30 is pushed by a jig when the first portion 22 is press-fitted into the housing 70. The second portion 32 also extends in the X-direction. The second portion 32 is to be inserted into and connected with a through hole (not shown) formed on the board (not shown). The coupling portion 34 couples the end portion in the negative X-direction of the first portion 22 with an end portion in the positive X-direction of the second portion 32 (one of end portions of the second portion 32 closer to the mating end 12). As best shown in FIG. 8 and FIG. 9, the first portion 22 and the second portion 32 are positioned on straight lines different from each other. The coupling portion 34 extends in the Z-direction and intersects with the X-direction. With this structure, the first portion 22 and the second portion 32 are positioned apart from with each other in the Z-direction. In other words, the first portion 22 and the second portion 32 are not aligned with each other.

As best shown in FIG. 8 and FIG. 9, the first portions 22 are arranged in a single row while the second portions 32 are arranged in two rows. In detail, as shown in FIG. 6 and FIG. 9, the coupling portions 34 of two USB 3.0 contacts 20 constituting one differential pair 21 extend in different directions from each other. The coupling portions 34 of two of the outermost USB 3.0 contacts 20 in the Y-direction (the width direction) extend along the negative Z-direction from the end portions in the negative X-direction of the first portions 22. The coupling portions 34 of the rest two of the USB 3.0 contacts 20 extend in the positive Z-direction from the end portions in the negative X-direction of the first portions 22. Thus, the second portions 32 of the USB 3.0 contacts 20 constituting one of the differential pairs 21 are positioned in different rows from each other. In every USB 3.0 contact 20 of the present embodiment, a boundary portion between the first portion 22 and the coupling portion 34 is bent while another boundary portion between the coupling portion 34 and the second portion 32 is also bent so that the pitches of the USB 3.0 contacts 20 are converted. Lengths of the coupling portions 34 of two USB 3.0 contacts 20 constituting one differential pair 21 are same as each other. Similarly, lengths of the first portions 22 are same as each other, and lengths of the second portions 32 are same as each other. In other words, according to the present embodiment, lengths of the signal transmitting paths of two USB 3.0 contacts 20 constituting one differential pair 21 are same as each other. Therefore, the differential pair 21 of the present embodiment can prevent skew which might be caused by different lengths of the signal transmission paths.

Each of widths of the second portion 32 and the coupling portion 34 of the USB 3.0 contact 20 according to the present embodiment is smaller than a width of the first portion 22 in the Y-direction. In other words, a width of a part of the USB 3.0 contact 20 positioned outside the housing 70 (i.e. the part extending from the inner wall portion 74 in the negative X-direction) is smaller than a width of the first portion 22 extending in the housing 70. With this structure, a distance between the second portions 32 becomes larger in the Y-direction. In detail, a distance between the second portions 32 of the innermost two USB 3.0 contacts 20, which are closer to the USB 3.0 contact 40, becomes larger. Thus, crosstalk can be reduced between two differential pairs 21.

As shown in FIG. 6 to FIG. 9, the USB 3.0 contact 40 has a specific first portion 42, a specific second portion 52 and a specific coupling portion 54. The specific first portion 42 and the specific second portion 52 extend in the X-direction. The specific coupling portion 54 couples the specific first portion 42 with the specific second portion 52. The specific first portion 42 has a contact portion 44 configured to be brought into contact with a ground contact (not shown) of the mating connector (not shown). The specific first portion 42 has a long and narrow plate-like shape. The specific first portion 42 is formed with press-fitted projections 46 and a projection 48. The press-fitted projections 46 are press-fitted into the inner wall portion 74 of the housing 70. When the press-fitted projections 46 are press-fitted into the housing 70, the projection 48 presses the specific first portion 42 onto an inner surface of the groove of the plate-like portion 76 so that the positioning of the specific first portion 42 is performed. One end portion in the negative X-direction of the specific first portion 42 is provided with a shoulder portion 50. The shoulder portion 50 is pushed by a jig when the specific first portion 42 is press-fitted into the housing 70. The specific second portion 52 is configured to be inserted into and connected with a through hole (not shown) formed on the board (not shown). The specific coupling portion 54 couples an end portion in the negative X-direction of the specific first portion 42 (one of end portions of the specific first portion 42 closer to the board-mount end 14) with an end portion in the positive X-direction of the specific second portion 52 (one of end portions of the specific second portion 52 closer to the mating end 12). As best shown in FIG. 8 and FIG. 9, the specific first portion 42 and the specific second portion 52 are positioned on straight lines different from each other. The specific coupling portion 54 extends in the Z-direction and intersects with the X-direction. Accordingly, the specific first portion 42 and the specific second portion 52 are positioned apart from with each other in the Z-direction. In other words, the specific first portion 42 and the specific second portion 52 are not aligned with each other.

In detail, the specific first portion 42 of the USB 3.0 contact 40 is longer than the first portion 22 of the USB 3.0 contact 20 in the X-direction. Widths of the specific second portion 52 and the specific coupling portion 54 are smaller than a width of the specific first portion 42 in the Y-direction.

The specific coupling portion 54 and the coupling portion 34 neighboring on the specific coupling portion 54 in the Y-direction extend in directions opposite to each other. The specific coupling portion 54 and the coupling portions 34 of the outermost USB 3.0 contacts 20 in the Y-direction extend in directions same as each other. Therefore, as shown in FIG. 5 and FIG. 9, as the connector 10 is seen along the X-direction, i.e. as the connector 10 is seen from below the board-mount end 14, the second portion 32 and the specific second portion 52 are arranged in a staggered configuration or a zigzag configuration. In other words, the second portions 32 of two USB 3.0 contacts 20 neighboring on each other in the Y-direction are arranged in rows different from each other. Likewise, the specific second portion 52 of the USB 3.0 contact 40 and the second portion 32 of the USB 3.0 contact 20 neighboring thereon in the Y-direction are arranged in rows different from each other. Thus, the second portions 32 and the specific second portion 52 are arranged in the zigzag manner. Therefore, a distance between the second portions 32 constituting one differential pair 21 becomes larger. Likewise, a distance between the second portion 32 and the specific second portion 52 becomes larger. In other words, a distance between the through holes (not shown) formed on the board (not shown) can be larger.

Although the above-explanation is made about the embodiment of present invention, the present invention is not limited thereto. For example, according to the aforementioned embodiment, the connector 10 is compliant with the USB 3.0 Standard-B, and the specific contact is the ground contact (the USB 3.0 contact 40). However, depending on a standard for the connector, the specific contact may be applied with any fixed electrical potential, and the connector may have no specific contact (the USB 3.0 contact 40: the ground contact).

The first portions 22, the specific first portion 42, the second portions 32 and the specific second portion 52 of the connector 10 of the aforementioned embodiment extend along the same direction (the X-direction). Namely, the connector 10 is of a straight type. However, the concept of the present invention may be applied to a right angle type connector, a mating surface of which is perpendicular to a board (not shown). Namely, the extending directions of the first portions 22 and the specific first portion 42 may be perpendicular to the extending directions of the second portions 32 and the specific second portion 52. Generally, it is however more difficult for a straight type connector, in comparison with a right angle type connector, to provide both reduction of crosstalk and pitch conversion. Therefore, application of the present invention to a straight type connector is more effective.

The USB 3.0 contact 40 is bent so as to have the specific coupling portion 54, and the axis of the specific first portion 42 and the axis of the specific second portion 52 are apart from each other. However, the present invention is not limited thereto. For example, the specific first portion 42 and the specific second portion 52 may be aligned if there is no restriction on distances between through holes (not shown) on a board (not shown). In other words, the USB 3.0 contact 40 may have no bent portion.

The present application is based on a Japanese patent application of JP2012-204154 filed before the Japan Patent Office on Sep. 18, 2012, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector to be mounted on a board and connectable with a mating connector in a predetermined direction, wherein:
the connector comprises contacts and a housing;
the contacts constitute two differential pairs;
the housing holds the contacts;
each of the contacts has a first portion, a second portion and a coupling portion;
the first portion is press-fitted into and held by the housing;
the first portion has a contact portion to be brought into contact with the mating connector;
the second portion is to be connected with and fixed on the board;
the coupling portion couples the first portion with the second portion;
the first portions are arranged in a single row while the second portions are arranged in two rows;
widths of the first portions are larger than widths of the second portions and the coupling portions in a width direction perpendicular to the predetermined direction; and
the second portions of the two contacts constituting one of the differential pairs belong to the rows different from each other.

2. The connector as recited in claim 1, wherein the first portions extend along the predetermined direction.

3. The connector as recited in claim 2, wherein the second portions extend along the predetermined direction.

4. The connector as recited in claim 3, wherein the coupling portions extend in a direction intersecting with the predetermined direction and have lengths same as each other.

5. The connector as recited in claim 1, the board being formed with through holes, wherein the second portions are inserted into and connected with the through holes.

6. The connector as recited in claim 1, further comprising a specific contact to be applied with a fixed electrical potential, wherein the specific contact is held by the housing and positioned between the two differential pairs in the width direction.

7. The connector as recited in claim 6, wherein:
the specific contact has a specific first portion and a specific second portion corresponding to the first portion and the second portion, respectively; and
the second portions and the specific second portion are arranged in a staggered configuration.

8. The connector as recited in claim 6, wherein:
the specific contact is a ground contact; and
the connector is compliant with the USB (Universal Serial Bus) 3.0 Standard-B.
